(19) United States
(12) Patent Application Publication
(10) Pub. No.: US 2026/0339186 A1
(43) Pub. Date: Oct. 29, 2026

(54) PROJECTION DEVICE

(71) Applicant: QISDA CORPORATION, Taoyuan City (TW)

(72) Inventors: Chih-Shiung CHIEN, Taoyuan City (TW); Ming-Kuen LIN, Taoyuan City (TW)

(73) Assignee: QISDA CORPORATION, Taoyuan City (TW)

(21) Appl. No.: 19/642,801

(22) Filed: Apr. 9, 2026

(30) Foreign Application Priority Data
Apr. 27, 2025 (CN) 202510541436.X

(51) Int. Cl. G03B 21/20; G03B 21/14

(52) U.S. Cl. CPC G03B 21/208; G03B 21/142; G03B 21/2066

(57) ABSTRACT

A projection device includes an illumination module providing an illumination beam, a prism module, a light valve and a lens module. The prism module includes first and second prisms. The first prism includes first and second right-angle prisms, each including inclined, upper, bottom, side and side-abutting surfaces. The side-abutting surfaces coincide, while the first bottom/side surfaces are respectively coplanar with the second side/bottom surfaces. The light valve converts the illumination beam into an imaging beam, with its imaging surface parallel to the second side surface and further with their long edges aligned and their short edges aligned. The first inclined surface is inclined at a predetermined angle relative to the first side surface, such that the illumination beam enters the first inclined surface at a specific incident angle. The second prism receives the imaging beam transmitted from the second inclined surface and outputs it to the lens module.

This application claims the benefit of People’s Republic of China patent application Serial No. 202510541436.X, filed Apr. 27, 2025, the invention of which are incorporated by reference herein in its entirety.

### TECHNICAL FIELD

The present invention relates to a projection device, and more particularly to a projection device having a smaller size.

### BACKGROUND

A projection device is capable of magnifying and displaying image signals on a projection screen, such that images are projected onto the projection screen to be presented to a user for viewing. One of the objectives of modern projection devices is the pursuit of miniaturization. However, due to specific requirements for optical path design, a certain volume is still required to accommodate the necessary designs. This causes large-volume projection devices to gradually lose their competitiveness.

### SUMMARY

The present invention relates to a projection device. The arrangement of a light valve and a prism module can be set without being inclined at an angle (for example, 45 degrees), thereby the overall height of the system can be reduced, and the size of the projection device can be further decreased.

One embodiment of the present invention provides a projection device including an illumination module, a prism module, a light valve, and a lens module. The illumination module is configured to provide an illumination beam. The prism module includes a first prism and a second prism. The first prism includes a first right-angle prism and a second right-angle prism. The first right-angle prism includes a first inclined surface, a first upper surface, a first bottom surface, a first side surface, and a first side-abutting surface. The first upper surface is parallel to the first bottom surface, and the first upper surface is respectively perpendicular to the first side surface, the first side-abutting surface, and the first inclined surface. The second right-angle prism includes a second inclined surface, a second upper surface, a second bottom surface, a second side surface, and a second side-abutting surface. The second upper surface is parallel to the second bottom surface, and the second upper surface is respectively perpendicular to the second side surface, the second side-abutting surface, and the second inclined surface. The second inclined surface and the second side surface intersect at a first short edge, and the second bottom surface and the second side surface intersect at a first long edge. The first side-abutting surface and the second side-abutting surface coincide with each other, the first bottom surface is coplanar with the second side surface, the first side surface is coplanar with the second bottom surface, the first inclined surface is adjacent to the second upper surface, and the second inclined surface is adjacent to the first upper surface. The second prism is disposed adjacent to the second inclined surface. The light valve is disposed adjacent to the second side surface and is configured to receive the illumination beam exiting from the second side surface and convert the illumination beam into an imaging beam. The light valve has an imaging surface, and the imaging surface is parallel to the second side surface. The imaging surface has a second long edge and a second short edge, the second long edge is parallel to the first long edge, and the second short edge is parallel to the first short edge. The first inclined surface is inclined at a predetermined angle relative to the first side surface, such that the illumination beam enters the first prism from the first inclined surface at a specific incident angle. The second inclined surface is a total internal reflection surface for the illumination beam and a transmission surface for the imaging beam. The second prism receives the imaging beam transmitted from the second inclined surface and outputs the imaging beam to the lens module.

Preferably, an illumination surface of the illumination beam illuminating the light valve is at an azimuth angle of 45° relative to the second long edge of the imaging surface.

Preferably, the first side-abutting surface of the first right-angle prism and the second side-abutting surface of the second right-angle prism are bonded to each other.

Preferably, the first right-angle prism and the second right-angle prism are an integral structure.

Preferably, the second prism has a primary light exit surface, the second prism outputs the imaging beam to the lens module from the primary light exit surface, and the primary light exit surface is parallel to the second side surface.

Preferably, the light valve includes a plurality of micromirrors, the micromirrors have a tilt angle, the tilt angle is α, and a range of the specific incident angle is 2α±10°.

Preferably, the specific incident angle is θ, and 19°≤θ≤39°.

Preferably, the projection device further includes an optical module disposed between the illumination module and the prism module.

Preferably, the optical module includes at least two lenses, one of the at least two lenses is disposed adjacent to the first prism and is inclined toward the first inclined surface.

Preferably, the one of the at least two lenses is attached to the first inclined surface.

Another embodiment of the present invention provides a projection device including an illumination module, a prism module, a light valve, and a lens module. The illumination module is configured to provide an illumination beam. The prism module includes a first prism and a second prism. The first prism includes a first flat surface, a second flat surface, a third flat surface, a fourth flat surface, a first inclined surface, and a second inclined surface. The first flat surface is parallel to the second flat surface, and the third flat surface is parallel to the fourth flat surface. The first flat surface is perpendicular to and adjacent to the third flat surface and the fourth flat surface, and intersects with the fourth flat surface at a first long edge. The first inclined surface is perpendicular to and adjacent to the first flat surface and the second flat surface, and is adjacent to the third flat surface and the fourth flat surface. The second inclined surface is perpendicular to and adjacent to the third flat surface and the fourth flat surface, and is adjacent to the first flat surface and the second flat surface. The second inclined surface intersects with the first flat surface at a first short edge and is inclined relative to the first flat surface. The second prism is disposed adjacent to the second inclined surface. The light valve is disposed adjacent to the first flat surface and is configured to receive the illumination beam exiting from the first flat surface and convert the illumination beam into an imaging beam. The light valve has an imaging surface, and the imaging surface is parallel to the first flat surface. The imaging surface has a second long edge and a second short edge, the second long edge is parallel to the first long edge, and the second short edge is parallel to the first short edge. The first inclined surface is inclined at a predetermined angle relative to the fourth flat surface, such that the illumination beam enters the first prism from the first inclined surface at a specific incident angle. The second inclined surface is a total internal reflection surface for the illumination beam and a transmission surface for the imaging beam. The second prism receives the imaging beam transmitted from the second inclined surface and outputs the imaging beam to the lens module.

Preferably, the first prism includes a first right-angle prism and a second right-angle prism, the first inclined surface is located on the first right-angle prism, the second inclined surface is located on the second right-angle prism, and the first prism is composed of the first right-angle prism and the second right-angle prism bonded to each other.

Preferably, shapes of the second flat surface and the third flat surface are triangular, shapes of the first flat surface and the fourth flat surface are trapezoidal, and shapes of the first inclined surface and the second inclined surface are rectangular.

Preferably, an illumination surface of the illumination beam illuminating the light valve is at an azimuth angle of 45° relative to the second long edge of the imaging surface.

Preferably, the second prism has a primary light exit surface, the second prism outputs the imaging beam to the lens module from the primary light exit surface, and the primary light exit surface is parallel to the first flat surface.

Preferably, the light valve includes a plurality of micromirrors, the micromirrors have a tilt angle, the tilt angle is α, and a range of the specific incident angle is 2α±10°.

Preferably, the specific incident angle is θ, and 19°≤θ≤39°.

Preferably, the projection device further includes an optical module disposed between the illumination module and the prism module.

Preferably, the optical module includes at least two lenses, one of the at least two lenses is disposed adjacent to the first prism and is inclined toward the first inclined surface.

Preferably, the one of the at least two lenses is attached to the first inclined surface.

In order to better understand the above and other aspects of the present invention, embodiments are described below in detail with reference to the accompanying drawings.

### BRIEF DESCRIPTION OF THE DRAWINGS

FIG. 1 is a schematic top view of a projection device according to one embodiment of the present invention.

FIG. 2 illustrates a perspective view of the first prism used for the projection device of FIG. 1.

FIG. 3 illustrates one embodiment of the composition of the first prism.

FIG. 4 is a schematic view showing the first prism and the light valve from a front perspective.

FIG. 5 illustrates a perspective view of the prism module and the light valve.

FIG. 6 illustrates one embodiment of the light valve.

FIG. 7 is a schematic view showing the prism module and the light valve from a top perspective.

### DETAILED DESCRIPTION

Embodiments of the present invention will be described in detail below with reference to the drawings as examples. In addition to these detailed descriptions, the present invention can be widely implemented in other embodiments. Any readily apparent substitutions, modifications, and equivalent changes of the described embodiments are included within the scope of the present invention, and shall be subject to the subsequent claims. In the description of the specification, many specific details and implementation examples are provided to give readers a more complete understanding of the present invention; however, these specific details and implementation examples should not be regarded as limitations of the present invention. Furthermore, well-known steps or elements are not described in detail to avoid causing unnecessary limitations to the present invention.

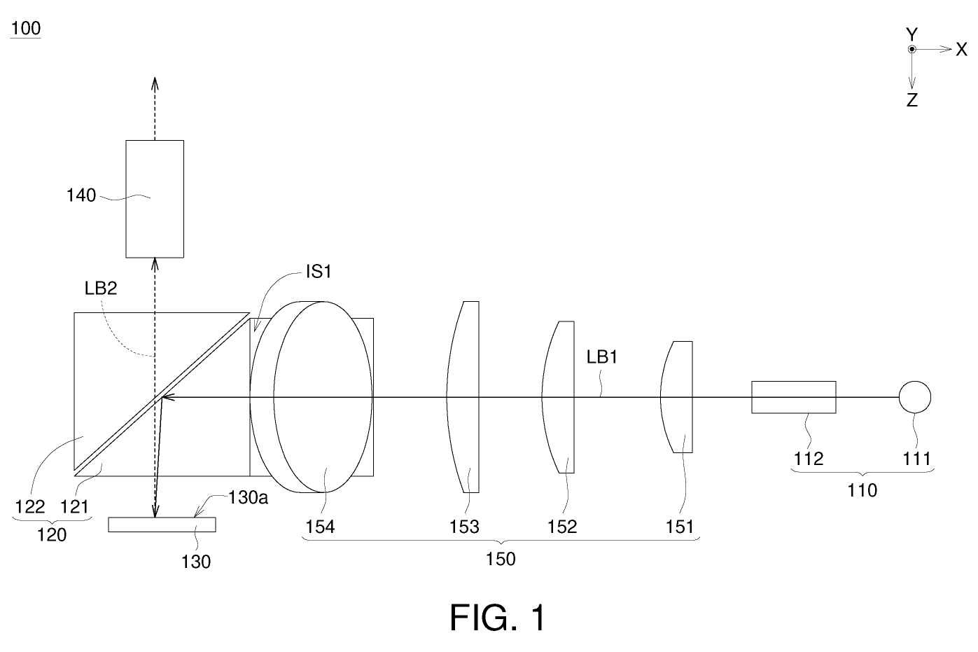

FIG. 1 is a schematic top view of a projection device 100 according to one embodiment of the present invention. Referring to FIG. 1, the projection device 100 at least includes an illumination module 110, a prism module 120, a light valve 130, and a lens module 140. The illumination module 110 is configured to provide an illumination beam LB1. The light valve 130 is configured to receive the illumination beam LB1 provided by the illumination module 110, and convert the illumination beam LB1 into an imaging beam LB2. The lens module 140 is configured to receive the imaging beam LB2, and project it onto a projection medium (for example, a projection screen or a human eye).

In one embodiment, the illumination module 110 may include a light source 111 and a light guiding element 112. The light source 111 emits the illumination beam LB1, and may include any light-emitting element, such as but not limited to a laser diode, a light emitting diode (LED), a mini LED, a micro LED, an organic light emitting diode (OLED), etc. In another embodiment, the light source 111 may also be an optical element assembly composed of optical elements (lenses, mirrors, phosphor wheels, or filter wheels) having different optical functions, which is not limited by the present invention. The light guiding element 112 transmits the illumination beam LB1 emitted by the light source 111.

The prism module 120 includes a first prism 121 and a second prism 122. The light valve 130 is disposed adjacent to the first prism 121. The illumination beam LB1 provided by the illumination module 110 enters the prism module 120 from the first prism 121, and then exits the first prism 121 to enter the light valve 130 after total internal reflection is generated in the first prism 121. After the light valve 130 converts the illumination beam LB1 into the imaging beam LB2, the imaging beam LB2 enters the prism module 120 from the first prism 121, then passes through the first prism 121 and the second prism 122 in sequence, and finally exits the prism module 120 from the second prism 122. Thereafter, the imaging beam LB2 exiting the prism module 120 from the second prism 122 is outputted to the lens module 140.

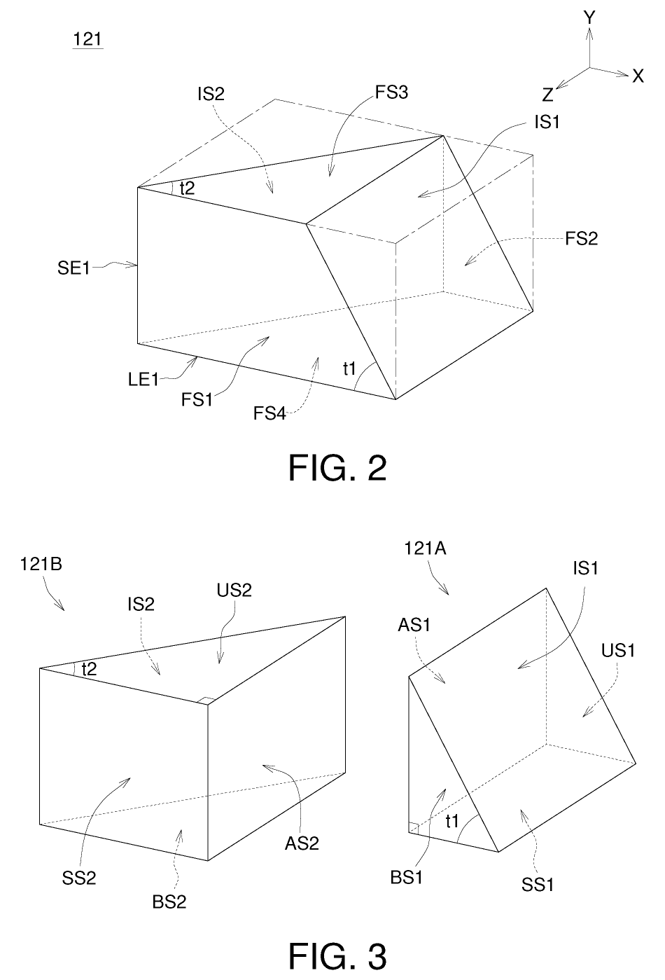

FIG. 2 illustrates a perspective view of the first prism 121 used for the projection device 100 of FIG. 1. Referring to FIG. 2, the first prism 121 may include a first flat surface FS1, a second flat surface FS2, a third flat surface FS3, a fourth flat surface FS4, a first inclined surface IS1, and a second inclined surface IS2. The first flat surface FS1 is parallel to the second flat surface FS2, wherein the first flat surface FS1 is a surface facing the positive direction of the Z-axis, and the second flat surface FS2 is a surface facing the negative direction of the Z-axis. The third flat surface FS3 is parallel to the fourth flat surface FS4, wherein the third flat surface FS3 is a surface facing the positive direction of the Y-axis, and the fourth flat surface FS4 is a surface facing the negative direction of the Y-axis. As shown in FIG. 2, normal vectors of both the first flat surface FS1 and the second flat surface FS2 are parallel to the Z-axis, and normal vectors of both the third flat surface FS3 and the fourth flat surface FS4 are parallel to the Y-axis. Therefore, both the first flat surface FS1 and the second flat surface FS2 are perpendicular to the third flat surface FS3 and the fourth flat surface FS4.

The first inclined surface IS1 is respectively adjacent to the first flat surface FS1, the second flat surface FS2, the third flat surface FS3, and the fourth flat surface FS4. In addition, the first inclined surface IS1 is respectively perpendicular to the first flat surface FS1 and the second flat surface FS2, but is not perpendicular to the third flat surface FS3 and the fourth flat surface FS4. The second inclined surface IS2 is respectively adjacent to the first flat surface FS1, the second flat surface FS2, the third flat surface FS3, and the fourth flat surface FS4. In addition, the second inclined surface IS2 is respectively perpendicular to the third flat surface FS3 and the fourth flat surface FS4, but is not perpendicular to the first flat surface FS1 and the second flat surface FS2. Specifically, the first inclined surface IS1 may be inclined by an angle t1 relative to the fourth flat surface FS4, and the second inclined surface IS2 may be inclined by an angle t2 relative to the first flat surface FS1, wherein the angle t1 and the angle t2 may respectively be acute angles less than 90 degrees.

Referring to FIG. 2, in one embodiment, shapes of the second flat surface FS2 and the third flat surface FS3 may be triangular, shapes of the first flat surface FS1 and the fourth flat surface FS4 may be trapezoidal, and shapes of the first inclined surface IS1 and the second inclined surface IS2 may be rectangular.

The first prism 121 may be an integral structure. For example, the first prism 121 may be formed by cutting using optical processing, but the present invention is not limited thereto. In one embodiment, referring to FIG. 2, a piece of suitable optical glass may be selected, and the volume of a triangular prism is removed by cutting at an angle t1 on the XY plane to form the first inclined surface IS1; the volume of a triangular prism is removed by cutting at an angle t2 on the XZ plane to form the second inclined surface IS2.

In another embodiment, the first prism 121 may be composed of two or more prisms. For example, the first prism 121 may be composed of two right-angle prisms. FIG. 3 illustrates one embodiment of the composition of the first prism 121. Referring to FIG. 3, the first prism 121 may include a first right-angle prism 121A and a second right-angle prism 121B. The first inclined surface IS1 is located on the first right-angle prism 121A, and the first right-angle prism 121A may further include a first upper surface US1, a first bottom surface BS1, a first side surface SS1, and a first side-abutting surface AS1. The first upper surface US1 is parallel to the first bottom surface BS1. Both the first upper surface US1 and the first bottom surface BS1 are adjacent to the first side surface SS1, the first side-abutting surface AS1, and the first inclined surface IS1, and are respectively perpendicular to the first side surface SS1, the first side-abutting surface AS1, and the first inclined surface IS1. Specifically, the shapes of the first upper surface US1 and the first bottom surface BS1 are right-angled triangles, and the shapes of the first side surface SS1, the first side-abutting surface AS1, and the first inclined surface IS1 are rectangular. The angle t1 between the first inclined surface IS1 and the first side surface SS1 is an acute angle less than 90 degrees.

The second inclined surface IS2 is located on the second right-angle prism 121B, and the second right-angle prism 121B may further include a second upper surface US2, a second bottom surface BS2, a second side surface SS2, and a second side-abutting surface AS2. The second upper surface US2 is parallel to the second bottom surface BS2. Both the second upper surface US2 and the second bottom surface BS2 are adjacent to the second side surface SS2, the second side-abutting surface AS2, and the second inclined surface IS2, and are respectively perpendicular to the second side surface SS2, the second side-abutting surface AS2, and the second inclined surface IS2. Specifically, the shapes of the second upper surface US2 and the second bottom surface BS2 are right-angled triangles, and the shapes of the second side surface SS2, the second side-abutting surface AS2, and the second inclined surface IS2 are rectangular. The angle t2 between the second inclined surface IS2 and the second side surface SS2 is an acute angle less than 90 degrees.

Here, referring to FIGS. 2 and 3, the first side-abutting surface AS1 of the first right-angle prism 121A may coincide with the second side-abutting surface AS2 of the second right-angle prism 121B. Specifically, the first bottom surface BS1 of the first right-angle prism 121A is coplanar with the second side surface SS2 of the second right-angle prism 121B, such that the first bottom surface BS1 and the second side surface SS2 constitute the first flat surface FS1 of the first prism 121. The first side surface SS1 of the first right-angle prism 121A is coplanar with the second bottom surface BS2 of the second right-angle prism 121B, such that the first side surface SS1 and the second bottom surface BS2 constitute the fourth flat surface FS4 of the first prism 121. The first upper surface US1 of the first right-angle prism 121A is the second flat surface FS2 of the first prism 121. The second upper surface US2 of the second right-angle prism 121B is the third flat surface FS3 of the first prism 121.

In one embodiment, the first side-abutting surface AS1 of the first right-angle prism 121A may be bonded to the second side-abutting surface AS2 of the second right-angle prism 121B. For example, the first side-abutting surface AS1 and the second side-abutting surface AS2 may be bonded to each other by an optical adhesive (such as UV glue) to form the first prism 121.

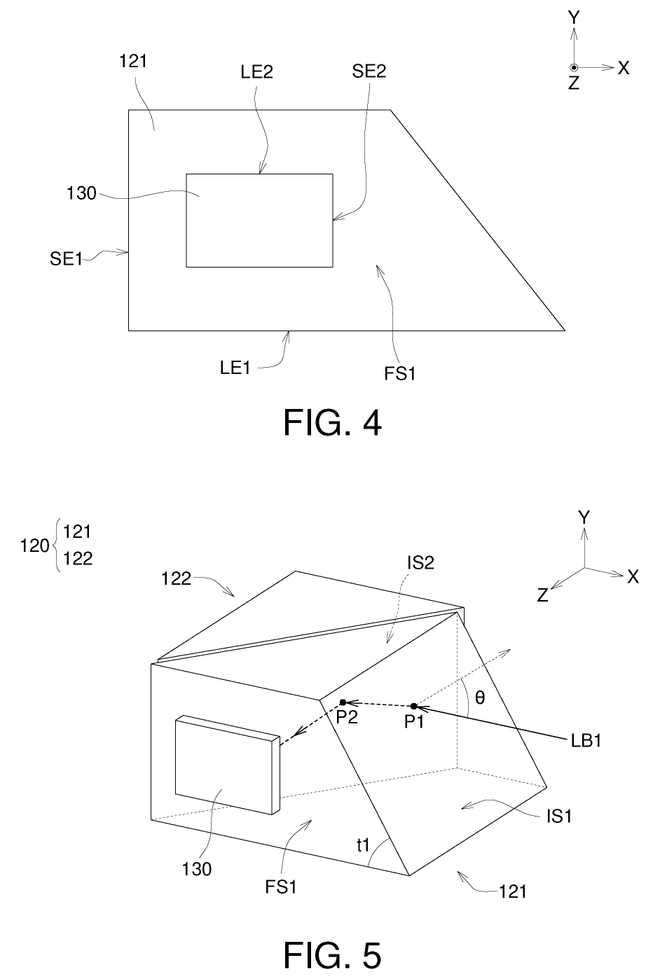

FIG. 4 is a schematic view showing the first prism 121 and the light valve 130 from a front perspective. Referring to FIGS. 2 and 4, if the first prism 121 is an integral structure, a first long edge LE1 may be an edge where the first flat surface FS1 and the fourth flat surface FS4 intersect, or an edge where the first flat surface FS1 and the third flat surface FS3 intersect; a first short edge SE1 may be an edge where the second inclined surface IS2 and the first flat surface FS1 intersect, wherein the first long edge LE1 and the first short edge SE1 are perpendicular to each other. Referring to FIGS. 2, 3, and 4, in the case where the first prism 121 is composed of the first right-angle prism 121A and the second right-angle prism 121B, the first long edge LE1 may be an edge where the second side surface SS2 and the second bottom surface BS2 intersect, or an edge where the second upper surface US2 and the second side surface SS2 intersect; the first short edge SE1 may be an edge where the second inclined surface IS2 and the second side surface SS2 intersect, wherein the first long edge LE1 and the first short edge SE1 are perpendicular to each other.

Referring to FIGS. 1, 3, and 4, the light valve 130 is disposed adjacent to the first flat surface FS1 (or the second side surface SS2), and may receive the illumination beam LB1 exiting from the first flat surface FS1 (or the second side surface SS2). The light valve 130 has an imaging surface 130a, and the imaging surface 130a is parallel to the first flat surface FS1 (or the second side surface SS2). In other words, both the imaging surface 130a and the first flat surface FS1 (or the second side surface SS2) are parallel to the XY plane. The imaging surface 130a has a second long edge LE2 and a second short edge SE2, wherein the second long edge LE2 and the second short edge SE2 are perpendicular to each other. FIG. 4 shows that the second long edge LE2 corresponds to the first long edge LE1, and the second short edge SE2 corresponds to the first short edge SE1. Furthermore, the second long edge LE2 is parallel to the first long edge LE1, and the second short edge SE2 is parallel to the first short edge SE1. Therefore, the imaging surface 130a of the light valve 130 and the first flat surface FS1 of the first prism 121 are arranged in a relationship where the long axis corresponds to the long axis (X-axis direction) and the short axis corresponds to the short axis (Y-axis direction), rather than being interleaved (where two long axes are interleaved or two short axes are interleaved).

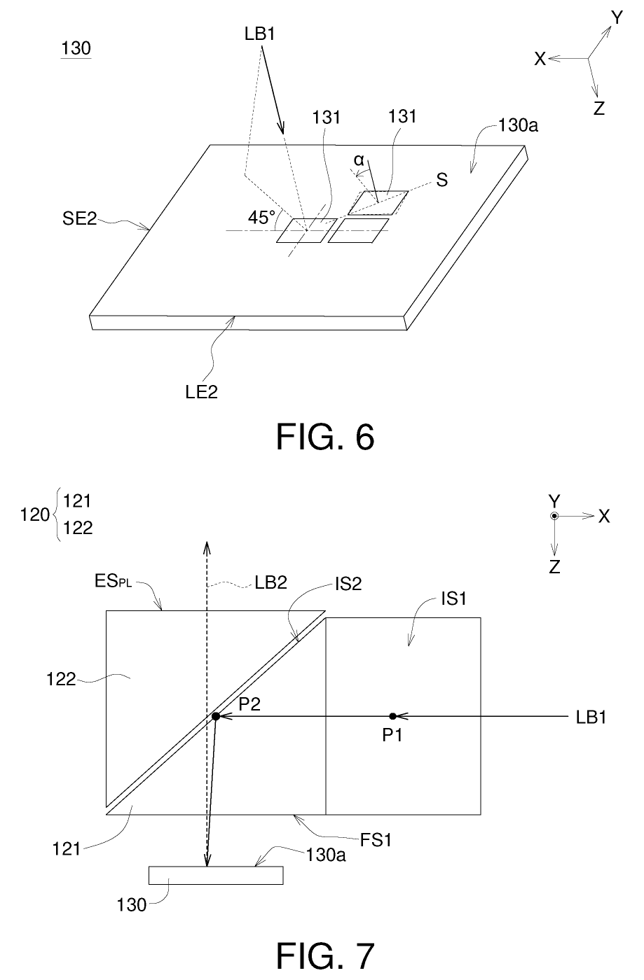

FIG. 5 illustrates a perspective view of the prism module 120 and the light valve 130; FIG. 6 illustrates one embodiment of the light valve 130; FIG. 7 is a schematic view showing the prism module 120 and the light valve 130 from a top perspective.

Referring to FIGS. 1 and 5 to 7, the second prism 122 of the prism module 120 is disposed adjacent to the second inclined surface IS2 of the first prism 121. The second inclined surface IS2 of the first prism 121 is a total internal reflection surface for the illumination beam LB1 and a transmission surface for the imaging beam LB2. The illumination beam LB1 enters the first prism 121 from the first inclined surface IS1 at a specific incident angle θ. When the illumination beam LB1 enters the first prism 121 at a position P1, refraction occurs, and then after total internal reflection is generated at a position P2 of the second inclined surface IS2, the illumination beam LB1 exits from the first flat surface FS1 and illuminates in a direction toward the imaging surface 130a of the light valve 130. In one embodiment, the light valve 130 is a corner-incident light valve, wherein the incident light illuminates from a diagonal direction of the light valve 130. As shown in FIGS. 5 and 6 , the illumination beams LB1 illuminating the light valve 130 form an illumination surface, and the illumination surface is at an azimuth angle of 45° relative to the second long edge LE2 of the imaging surface 130a. By designing a predetermined angle t1 interposed between the first inclined surface IS1 and the fourth flat surface FS4, the illumination beam LB1 can enter the first prism 121 from the first inclined surface IS1 at the specific incident angle θ, and when exiting from the first flat surface FS1, the illumination beam LB1 can illuminate the light valve 130 from the diagonal direction of the light valve 130. At the same time, such a design only requires one incident surface (i.e., the first inclined surface IS1) inclined at the predetermined angle t1 to achieve the condition of illuminating the light valve 130 from the diagonal direction, without requiring the imaging surface 130a of the light valve 130 and the first flat surface FS1 of the first prism 121 to be arranged in an interleaved configuration to achieve the diagonal illumination condition. Therefore, the overall system height can be reduced, thereby decreasing the size of the projection device.

Referring to FIG. 6, the light valve 130 may include a plurality of micromirrors 131, and the micromirrors 131 are arranged in an array on the imaging surface 130a. Each micromirror 131 includes a rotation axis S, and the micromirror 131 may rotate along the rotation axis S to modulate a mirror tilt angle, thereby changing the incident and reflection angles of the illumination beam LB1. Referring to FIGS. 5 and 6, in one embodiment, the tilt angle of the micromirror 131 is α, then the range of the specific incident angle θ of the illumination beam LB1 is 2α±10°. For example, if the tilt angle of the micromirror 131 is 14.5°, then the range of the specific incident angle θ is 19°≤θ≤39°.

Referring to FIGS. 1 and 7, the light valve 130 converts the illumination beam LB1 into the imaging beam LB2, and the imaging beam LB2 then enters the first prism 121 from the first flat surface FS1 and transmits through the second inclined surface IS2. The second prism 122 receives the imaging beam LB2 transmitted from the second inclined surface IS2 and outputs the imaging beam LB2 to the lens module 140. The second prism 122 has a primary light exit surface ES_{PL}. The imaging beam LB2 exits the second prism 122 from the primary light exit surface ES_{PL} and is directed toward the lens module 140. As shown in FIG. 7, the primary light exit surface ES_{PL} may be parallel to the first flat surface FS1. Therefore, optical path differences of the plurality of imaging beams LB2 within the prism module 120 are all the same, which helps ensure the resolution capability of the lens module 140.

Referring to FIG. 1, the projection device 100 may further include an optical module 150 disposed between the illumination module 110 and the prism module 120. The optical module 150 may include at least two lenses, and one of the lenses is disposed adjacent to the first prism 121 and inclined toward the first inclined surface IS1. For example, in one embodiment, the optical module 150 may include a first lens 151, a second lens 152, a third lens 153, and a fourth lens 154. The first lens 151, the second lens 152, the third lens 153, and the fourth lens 154 may be condenser lenses. The illumination beam LB1 enters the prism module 120 after sequentially passing through the first lens 151, the second lens 152, the third lens 153, and the fourth lens 154. The fourth lens 154 may be disposed adjacent to the first prism 121 and is further inclined toward the first inclined surface IS1, for example, also at an angle t1 (labeled in FIGS. 2, 3, and 5), to improve light collection efficiency. In one embodiment, a gap exists between the fourth lens 154 and the first inclined surface IS1 of the first prism 121, but the present invention is not limited thereto. In another embodiment, the fourth lens 154 may also be attached (for example, by bonding or other fixed connection methods) to the first inclined surface IS1 of the first prism 121 to further reduce the overall length of the system.

Although the present invention has been disclosed above with reference to specific embodiments, it is not intended to limit the present invention. Those skilled in the art to which the present invention pertains may make various modifications and refinements without departing from the spirit and scope of the present invention. Therefore, the scope of the present invention shall be defined by the appended claims.

What is claimed is:

1. A projection device comprising:
an illumination module configured to provide an illumination beam;
a prism module comprising:
a first prism comprising:
a first right-angle prism comprising a first inclined surface, a first upper surface, a first bottom surface, a first side surface and a first side-abutting surface, the first upper surface being parallel to the first bottom surface, and the first upper surface being respectively perpendicular to the first side surface, the first side-abutting surface and the first inclined surface; and
a second right-angle prism comprising a second inclined surface, a second upper surface, a second bottom surface, a second side surface and a second side-abutting surface, the second upper surface being parallel to the second bottom surface, the second upper surface being respectively perpendicular to the second side surface, the second side-abutting surface and the second inclined surface, the second inclined surface and the second side surface intersecting at a first short edge, and the second bottom surface and the second side surface intersecting at a first long edge;
wherein the first side-abutting surface and the second side-abutting surface coincide with each other, the first bottom surface is coplanar with the second side surface, the first side surface is coplanar with the second bottom surface, the first inclined surface is adjacent to the second upper surface, and the second inclined surface is adjacent to the first upper surface; and
a second prism disposed adjacent to the second inclined surface;
a light valve disposed adjacent to the second side surface, configured to receive the illumination beam exiting from the second side surface and convert the illumination beam into an imaging beam, the light valve having an imaging surface, the imaging surface being parallel to the second side surface, the imaging surface having a second long edge and a second short edge, the second long edge being parallel to the first long edge, and the second short edge being parallel to the first short edge; and
a lens module;
wherein the first inclined surface is inclined at a predetermined angle relative to the first side surface, such that the illumination beam enters the first prism from the first inclined surface at a specific incident angle;
the second inclined surface is a total internal reflection surface for the illumination beam and a transmission surface for the imaging beam, and the second prism receives the imaging beam transmitted from the second inclined surface and outputs the imaging beam to the lens module.

2. The projection device according to claim 1, wherein an illumination surface of the illumination beam illuminating the light valve is at an azimuth angle of 45° relative to the second long edge of the imaging surface.

3. The projection device according to claim 1, wherein the first side-abutting surface of the first right-angle prism and the second side-abutting surface of the second right-angle prism are bonded to each other.

4. The projection device according to claim 1, wherein the first right-angle prism and the second right-angle prism are an integral structure.

5. The projection device according to claim 1, wherein the second prism has a primary light exit surface, the second prism outputs the imaging beam to the lens module from the primary light exit surface, and the primary light exit surface is parallel to the second side surface.

6. The projection device according to claim 1, wherein the light valve comprises a plurality of micromirrors, the micromirrors have a tilt angle, the tilt angle is α, and a range of the specific incident angle is 2α±10°.

7. The projection device according to claim 1, wherein the specific incident angle is θ, and 19°≤θ≤39°.

8. The projection device according to claim 1, further comprising an optical module disposed between the illumination module and the prism module.

9. The projection device according to claim 8, wherein the optical module comprises at least two lenses, one of the at least two lenses is disposed adjacent to the first prism and is inclined toward the first inclined surface.

10. The projection device according to claim 9, wherein the one of the at least two lenses is attached to the first inclined surface.

11. A projection device comprising:
an illumination module configured to provide an illumination beam;
a prism module comprising:
a first prism comprising a first flat surface, a second flat surface, a third flat surface, a fourth flat surface, a first inclined surface and a second inclined surface, the first flat surface being parallel to the second flat surface, the third flat surface being parallel to the fourth flat surface, the first flat surface being perpendicular to and adjacent to the third flat surface and the fourth flat surface, and intersecting with the fourth flat surface at a first long edge, the first inclined surface being perpendicular to and adjacent to the first flat surface and the second flat surface, and being adjacent to the third flat surface and the fourth flat surface, the second inclined surface being perpendicular to and adjacent to the third flat surface and the fourth flat surface, and being adjacent to the first flat surface and the second flat surface, and the second inclined surface intersecting with the first flat surface at a first short edge and being inclined relative to the first flat surface; and
a second prism disposed adjacent to the second inclined surface;
a light valve disposed adjacent to the first flat surface, configured to receive the illumination beam exiting from the first flat surface and convert the illumination beam into an imaging beam, the light valve having an imaging surface, the imaging surface being parallel to the first flat surface, the imaging surface having a second long edge and a second short edge, the second long edge being parallel to the first long edge, and the second short edge being parallel to the first short edge; and
a lens module;
wherein the first inclined surface is inclined at a predetermined angle relative to the fourth flat surface, such that the illumination beam enters the first prism from the first inclined surface at a specific incident angle;
the second inclined surface is a total internal reflection surface for the illumination beam and a transmission surface for the imaging beam, and the second prism receives the imaging beam transmitted from the second inclined surface and outputs the imaging beam to the lens module.

12. The projection device according to claim 11, wherein the first prism comprises a first right-angle prism and a second right-angle prism, the first inclined surface is located on the first right-angle prism, the second inclined surface is located on the second right-angle prism, and the first prism is composed of the first right-angle prism and the second right-angle prism bonded to each other.

13. The projection device according to claim 11, wherein shapes of the second flat surface and the third flat surface are triangular, shapes of the first flat surface and the fourth flat surface are trapezoidal, and shapes of the first inclined surface and the second inclined surface are rectangular.

14. The projection device according to claim 11, wherein an illumination surface of the illumination beam illuminating the light valve is at an azimuth angle of 45° relative to the second long edge of the imaging surface.

15. The projection device according to claim 11, wherein the second prism has a primary light exit surface, the second prism outputs the imaging beam to the lens module from the primary light exit surface, and the primary light exit surface is parallel to the first flat surface.

16. The projection device according to claim 11, wherein the light valve comprises a plurality of micromirrors, the micromirrors have a tilt angle, the tilt angle is α, and a range of the specific incident angle is 2α±10°.

17. The projection device according to claim 11, wherein the specific incident angle is θ, and 19°≤θ≤39°.

18. The projection device according to claim 11, further comprising an optical module disposed between the illumination module and the prism module.

19. The projection device according to claim 18, wherein the optical module comprises at least two lenses, one of the at least two lenses is disposed adjacent to the first prism and is inclined toward the first inclined surface.

20. The projection device according to claim 19, wherein the one of the at least two lenses is attached to the first inclined surface.
